(19) United States
(12) Patent Application Publication
(10) Pub. No.: US 2007/0255798 A1
(43) Pub. Date: Nov. 1, 2007

(54) Brokered virtualized application execution

(75) Inventor: Manfred Schneider, Nussloch (DE)

Correspondence Address: SAP/BLAKELY, 1279 OAKMEAD PARKWAY, SUNNYVALE, CA, 94085-4040, US

(73) Assignee: SAP AG

(21) Appl. No.: 11/412,339

(22) Filed: Apr. 26, 2006

(51) Int. Cl. G06F 15/16

(52) U.S. Cl. 709/217

(57) ABSTRACT

Methods and apparatuses enable brokering the execution of an application. Rather than setting up a complete application execution environment including hardware and software, an execution broker enables execution of an application in a system that is generated or made available in response to a request to execute the application. Some or all components of the hardware and/or software can be virtualized through resources available in one or more backend systems. The request may include a configuration description of a hardware platform and a software environment on which to execute the application. In one embodiment, the configuration of the hardware and/or the software is derived (e.g., based on minimum system requirements and/or client preferences). In response to receiving the request, a hardware platform and a software environment based on the configuration description are generated, to generate the application execution environment for the requested application.

### FIELD

Embodiments of the invention relate to resource brokering, and more particularly to brokering the execution of an application.

### BACKGROUND

To execute a software application, traditional systems require the occurrence of several conditions. On a high level to an end user, the process of executing an application may appear to be no more complicated than starting a computing device, which typically automatically boots an operating system, after which the user can start the application. However, the actual complexity of executing the application includes buying, installing and setting up computer hardware, buying, installing, booting, and configuring an operating system on the computer hardware, buying, installing, and configuring an application on the operating system. Only after these steps are completed can an application be traditionally executed.

Generally the procedures involved in executing an application have multiple parts, each of which must be traditionally performed in a sequence, and asynchronously over a certain period of time (e.g., hours or days). In many scenarios, an end user or administrator would prefer to start an optimized application immediately, even if the application requires specific hardware, a specific operating system. If the specific hardware or operating system are not owned or installed, the end user may be unable to execute the desired application until after the required components are purchased and configured, which introduces delay.

### SUMMARY

An execution broker enables execution of an application in a system that is generated or made available in response to a request to execute the application. The request may include a configuration description of a hardware platform and a software environment on which to execute the application. In one embodiment, the configuration of the hardware and/or the software is derived (e.g., based on minimum system requirements and/or client preferences). In response to receiving the request, a hardware platform and a software environment based on the configuration description are generated. Some or all of the hardware and/or software can be virtualized. The application is executed on the generated software environment running on the generated hardware platform.

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1 is a block diagram of an embodiment of an execution broker coupled to various resources.

FIG. 2 is a flow diagram of an embodiment of brokering execution of an application.

FIG. 3 is a block diagram of an embodiment of an execution broker accessed via an access module.

FIG. 4 is a block diagram of an embodiment of an execution broker.

FIG. 5 is a flow diagram of an embodiment of brokering execution of an application.

### DETAILED DESCRIPTION

As used herein, references to one or more “embodiments” are to be understood as describing a particular feature, structure, or characteristic included in at least one implementation of the invention. Thus, phrases such as “in one embodiment” appearing herein may describe various embodiments and implementations of the invention, and do not necessarily all refer to the same embodiment. However, they are also not necessarily mutually exclusive. Descriptions of an overview of embodiments of the invention are provided below, followed by a more detailed description of certain details and implementations made with reference to the drawings.

A system with an execution broker as described herein allows execution of an application with a single or a small number of commands, without having to buy, install, set up, or configure the hardware, operating system and application. The execution broker can create or make available the required hardware and software environment in response to a request, and in a relatively short amount of time. Thus, end users do not need to set up a complete application execution environment. Rather, the application execution environment is generated upon request. The execution broker dynamically provides the components necessary for execution of the application. Some or all components of the hardware and/or software can be virtualized through virtualization managers to create or obtain the required components. After providing the execution environment, the execution broker triggers the execution of the application, which is made available to the end user.

In one embodiment, the execution broker and the resource managers set up an execution environment on a single virtualized computing resource. In other embodiments, an application is executed across multiple hardware environments. Thus, the execution broker may set up multiple virtualized execution environments for one application, or set up multiple hardware resources with a single request. The execution broker may also execute multiple applications with a single request.

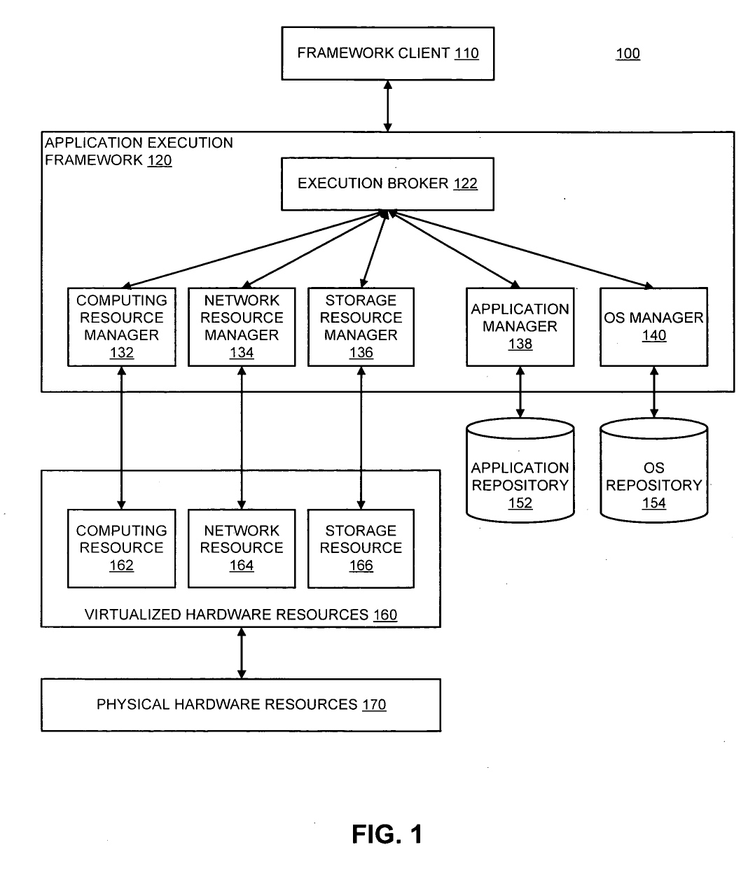

FIG. 1 is a block diagram of an embodiment of an execution broker coupled to various resources. System 100 includes framework client 110, which represents a client device through which a request is made for an application. Framework client 110 may be, for example, a desktop computer, a laptop computer, a personal digital assistant (PDA) or equivalent device, a terminal device, etc. Client 110 is coupled to application execution framework 120, which is an abstraction that represents one or more hardware and software resources through which client 110 obtains access to an application. As used herein, one component being coupled to another refers to an association, whether physical, electrical, or communicative, or some combination. In one embodiment, application execution framework 120 resides on an enterprise server, and is accessible through a remote access service or portal or other network connectivity mechanism. In an alternate embodiment, application execution framework 120 represents multiple components of separate physical devices in a network.

Application execution framework 120 includes execution broker 122, which could be software, hardware, or some combination. Execution broker 122 provides access to an application in response to a request received from client 110. Client 110 may include a stub or agent program running that has awareness of execution broker 122. The agent may provide a link to execution broker 122 to enable client 110 to provide a request for an application. Execution broker may include one or more stack managers and/or may have access to one or more managers. Certain components or managers shown may be optional, for example, if certain resources are handled locally, and only certain resources are brokered.

In one embodiment, execution broker 122 has direct access to certain resources. For example, execution broker 122 may directly broker computing or processing resources. In another embodiment, execution broker 122 is aware of other managers that directly access certain resources. For example, execution broker 122 may have access to a middleware agent that accesses a resource (e.g., storage resource middleware).

Execution broker 122 may be coupled to computing resource manager 132, which represents one or more software and/or hardware elements to provide access to computing or processing resources. Computing resource manager 132 may generate or manage computing resource 162, which represents a virtualized hardware resource 160. Computing resource 162 in turn is generated from physical resources 170, which represents actual hardware components or combinations of hardware and software components. Physical resource 170 may, for example, be a bank, rack, or other device having multiple allocatable or assignable resources. The physical resources can be logically assigned to computing resource manager 132, which controls the execution stack for one or more logical groups of resources. Thus, computing resource 162 can represent a logical allocation of allocatable or non-dedicated resources. Computing resource manager 132 manages computing resource 162, which can in turn be provided to client 110 in response to a request to execute an application. Execution broker 122 and/or computing resource manager 132 may determine what resources are needed to execute the application requested by client 110. For example, the application may require a certain minimum amount of processing power, e.g., processor speed, core configuration (e.g., dual or quad core), dedicated processor time, multithreading support, etc. Computing resource manager 132 enables execution broker to dynamically and synchronously create basic servers with central processing units (CPUs), main memory, bus systems, etc. The request from client 110 may explicitly indicate the processing requirements, or the requirements can be derived from a knowledge of what is a minimum required by the application.

In one embodiment, computing resource manager 132 manages specific hardware resource configurations. For example, instead of having access to a specifiable configuration of computing resources, computing resource 162 may be one of multiple selectable hardware machines, each with a fixed configuration. Thus, computing resource manager 132 can determine a hardware resource that most closely matches a request by client 110, and select form among available hardware configurations, rather than generating a specific configuration from non-fixed resources. In one embodiment, computing resource manager 132 has access to both available selectable configurations, as well as to specifiable resources. In one embodiment, computing resource manager 132 prefers available hardware configurations over resources that must be logically generated. Besides physical resources that are dedicated to providing computing resources to requesting clients, computing resource 162 may also include components of participants of a grid network. Grid participants may make resources available for use by execution broker 122.

Execution broker 122 may be coupled to network resource manager 134, which represents one or more software and/or hardware elements to dynamically and synchronously or asynchronously create network resources (e.g., network interface cards (NICs), hubs, switches, routers, firewalls, etc.). Similar to computing resource manager 132 with computing resource 162, network resource manager 134 can create virtualized network resource 164 from allocatable resources. The resources may include hardware with fixed configurations and/or hardware that is more flexibly assigned through specifying a configuration that is generated for the client request. The configuration of network resources can be specified in a request by client 110 and/or derived based on known configuration requirements for the requested application or requested system. In one embodiment, fixed configuration resources may be preferred over non-fixed resources.

Execution broker 122 may be coupled to storage resource manager 136, which represents one or more software and/or hardware elements to dynamically and synchronously or asynchronously create or provide storage resources (e.g., filesystems, partitions, volumes, etc.). An example of a mechanism that provides storage resource management may be STORAGE VIRTUALIZATION SOLUTIONS available from NETWORK APPLIANCE, INC. of Sunnyvale, Calif. Storage resource manager 136 provides access to storage resource 166, which may be a virtualized resource, as with other hardware resources discussed above. Storage resource 166 may include specific non-volatile storage devices, and/or entire filesystems or backend storage systems.

In one embodiment, physical hardware resources 170, and virtualized hardware resources 160 are resources on a device that incorporates execution broker 122. Thus, an execution broker can be incorporated on a resource farm. Physical resources 170 may be part of devices that offer computing, storage, and network resources and are managed by specialized physical resource virtualization middleware, for example, ESX SERVER products available from VMWARE, INC. of Palo Alto, Calif. Alternatively, physical resources 170 may include multiple separate devices form which virtualized hardware resources 160 are allocated in response to a request from client 110. Note that the request from client 110 may not necessarily explicitly request or require any hardware resources, but execution broker 122 determines that hardware resources should be allocated to provide a more optimized environment on which to execute one or more applications requested by client 110.

Execution broker 122 may be coupled to application manager 138, which represents one or more software and/or hardware elements to access and provide applications. For example, application manager 138 may have access to application repository 152. In one embodiment, application repository 152 includes, and can provide to execution broker 122, detailed configuration information about an application. Thus, execution broker 122 can be aware of what hardware and operating system resources are needed to execute a particular application. Such information can be loaded into application repository 152, for example, when an application is loaded into application repository 152. Thus, application repository 152 may provide information regarding necessary hardware, CPUs, main memory, networks, disk space, etc., as well as necessary software components. Software components may include databases, libraries, runtime containers, etc. In one embodiment, application manager 138 provisions an application on an operating system, for example, by installing, copying, or cloning the application, or by providing operating system and/or application images that can be executed. In an alternate embodiment, application manager 138 merely provisions applications, and operating systems are provisioned by a separate operating system (OS) manager (such as OS manager 140).

Execution broker 122 may be coupled to operating system (OS) manager 140, which represents one or more software and/or hardware elements to access and provide an operating system. OS manager 140 may access OS repository 154 to obtain necessary components (kernels, drivers, libraries, etc.) to provide an operating system. In one embodiment, OS repository 154 includes information regarding resources that are needed execute a particular operating system, and can make execution broker 122 aware of such requirements. OS repository 154 may include operating systems, and may represents an OS image archive to enable OS manager 140 to dynamically and synchronously or asynchronously provision and configure an operating system.

In one embodiment, physical resources 170 and/or applications and/or operating systems can be long-running. Long-running refers to a backend that is executing or ready to execute when a request to provision the resource is received. Thus, in contrast to receiving a request and initiating resources, which incurs delay costs, resources can be ready to execute upon receipt of a request. Applications and/or operating systems can be loaded into memory (volatile) and ready to be provisioned, instead of stored on disk and being loaded when a request is received. Thus, although system 100 could be operated by bringing resources online as demanded, a significant improvement in waiting time can be achieved by having long-running backend systems.

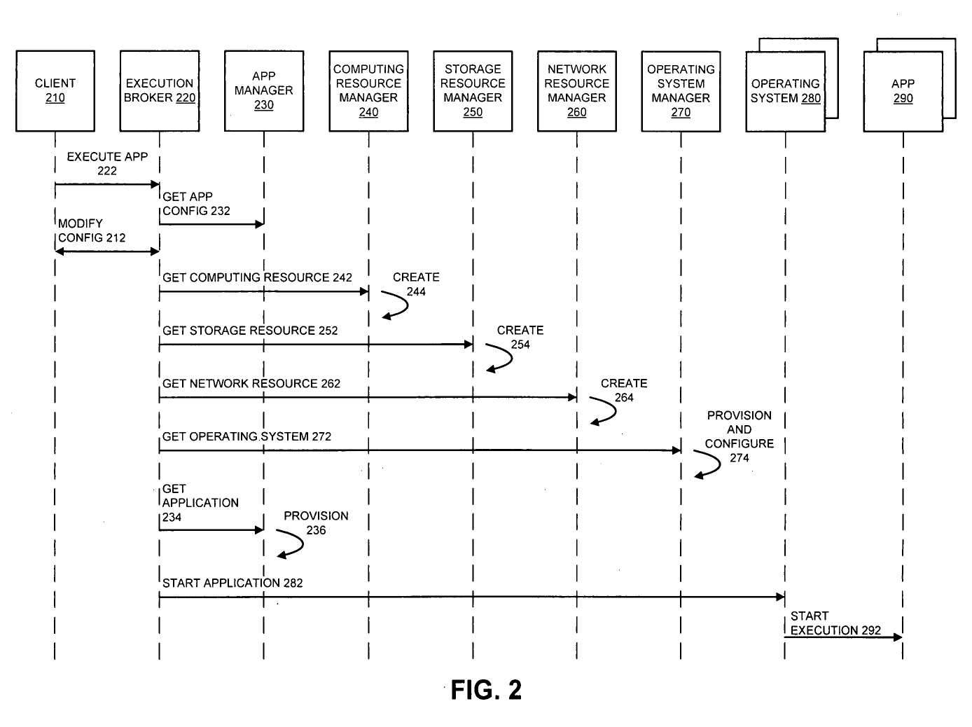

FIG. 2 is a flow diagram of an embodiment of brokering execution of an application. Through embodiments of agents/managers as described above, and other embodiments described below, end-to-end application execution can be as shown in FIG. 2. Client 210 generates a request to execute an application, 222, which is sent to execution broker 220. The request may indicate a software and/or hardware configuration description to execute the application. Execution broker 220 may infer certain configuration information through the use of one or more repositories, or configuration information stored on execution broker 220. Additionally, client 210 can register with execution broker 220 to indicate certain configuration preferences, such as indicating a cost (e.g., a maximum), a quality of service (e.g., maximum delay times, guaranteed prioritized scheduling), a guaranteed service level (e.g., through a service level agreement (SLA)), an availability of the hardware (e.g., dedicated resources, guaranteed resource time, etc.).

In one embodiment, execution broker 220 may guide client 210 through a procedure to determine system configuration for the client. For example, execution broker 220 could provide a default configuration suggestion to client 210. The default configuration can be for hardware, software, or both. The default could be determined on an individual client basis, as well as by group, or class of client (e.g., based on user credentials). Any resource of which execution broker 220 is aware, either on its own, or through the use of the various managers, can be referred to as “known” resources. The default configuration is provided based on known resources. Client 210 can modify the suggested default configuration by making selections from among a list of options (e.g., execution broker 220 can provide a list of available resource configurations that can be selected by client 210). Separate guided procedures can be performed for hardware and software, or a single guided procedure can be used for both.

Execution broker 220 issues a command or sends a request to application manager 230 to obtain the application configuration, 232. As discussed above, application manager 230 may include a repository of information that indicates for each available application what resource configuration is needed. With a configuration selected, client 210 and execution broker 220 can optionally modify a configuration, 212, for example, through a guided procedure as mentioned above.

When a configuration is determined, execution broker 220 can engage agents to provision the resources necessary to fulfill the configuration. Thus, execution broker commands or requests a computing resource, 242, from computing resource manager 240. In response to the request, computing resource manager 240 creates the resource, 244. The creation of a resource is discussed herein, and generally refers to virtualizing or otherwise obtaining or selecting resources to fulfill the request of client 210.

Execution broker 220 also requests a storage resource, 252, from storage resource manager 250. Storage resource manager 250 creates an appropriate storage resource, 254, which is made available to execute the requested application. Execution broker 220 requests a network resource, 262, from network resource manager 260, which creates the resource in response to receiving the request, 264. Execution broker 220 may also request one or more operating systems, 272, from operating system manager 270, which provisions and configures the operating systems, 274, in response to receiving the request. The operating system runs on the provisioned hardware. Not all managers will be accessed in all cases. The end-to-end example shown here is merely illustrative of various possible operations.

With resources provisioned, execution broker 220 obtains the application, 234, from application manager 230, which provisions the application, 236. Execution broker 220 can start an application, 282, on an operating system 280. One or more applications 290 can be the subject of the request by client 210 for execution. The one or more applications 290 are executed, 292, on operating system 280.

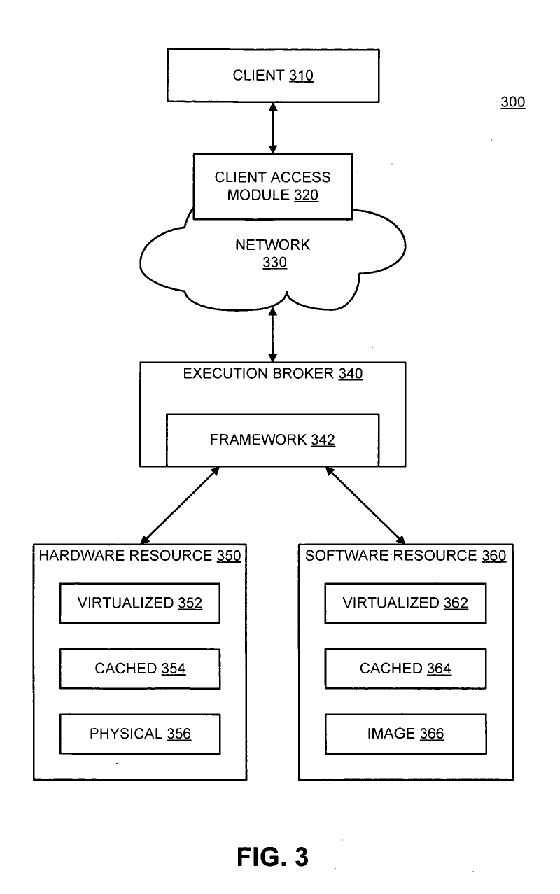

FIG. 3 is a block diagram of an embodiment of an execution broker accessed via an access module. System 300 includes client 310 that requests execution of an application. The discussions herein regarding the request parameters (i.e., a configuration), execution broker 340 providing a default configuration, and execution broker 340 and client 310 exchanging information to modify a suggested default configuration apply equally well to system 300 as to other embodiments described herein.

Client 310 accesses network 330 through client access module 320. Client access module 320 may include one or more components that run on client 310. Client access module 320 represents any type of remote access mechanism, and may be, for example, a WINDOWS TERMINAL SERVER (WTS), available from MICROSOFT CORPORATION, of Redmond, Wash., an access platform available from CITRIX SYSTEMS, INC., of Fort Lauderdale, Fla., or other Internet portal. The remote access can be to any type of network, and network 330 may be or include a local area network (LAN), a wireless network, a virtual private network (VPN), a virtual LAN (VLAN), a wide area network (e.g., the Internet), etc. Thus, execution broker 340 may be remote from client 310, which accesses execution broker 340 through client access module 320 over network 330.

Execution broker 340 includes framework 342, which represents the management or aggregation role that execution broker 340 may have. Framework 342 represents logic or intelligence to enable execution broker 340 to access hardware and/or software resource brokers and/or access hardware and/or software resources.

Hardware resource 350 is generated through framework 342 to provide a hardware platform or environment on which to execute an application requested by client 310. Likewise, software resource 360 is generated through framework 342 to provide a software environment or platform on which to execute the application requested by client 310. As used herein, a platform or environment refers to a configuration of resources on which applications may execute. A hardware platform may include processors, memory, connecting logic and circuits/systems, etc. A software platform refers generally to an operating system on which an application can operate, as well as other software components that may be needed for the application to operate.

Hardware resource 350 represents one or more resources generated in response to a request by client 310 to execute an application, to provide a hardware platform on which to execute the requested application. Hardware resource 350 may include one or more of virtualized hardware resource(s) 352, cached hardware configuration(s) 354 (i.e., a stored or cached logical hardware configuration that can be re-provisioned from one client to another), and/or physical hardware 356. Note that at the base level, all hardware resources 352-356 are made up of physical hardware resources; however, physical hardware 356 refers specifically here to non-provisioned hardware that may be provisioned. Execution broker 340 does not necessarily always use virtualized resources for all required components. If execution broker 340 is aware of, for example, real computing resources, real storage resources, or real network resources, execution broker 340 can assign and provision for use such real resources for the application execution.

Software resource 360 represents one or more resources generated in response to a request by client 310 to execute an application, to provide a software environment on which to execute the requested application. Software resource 360 may include one or more of virtualized software resource(s) 362, cached software resources 364 (e.g., a copy stored in volatile memory), and/or image 366, which represents a local or remote image of a software component that can be accessed for client 310.

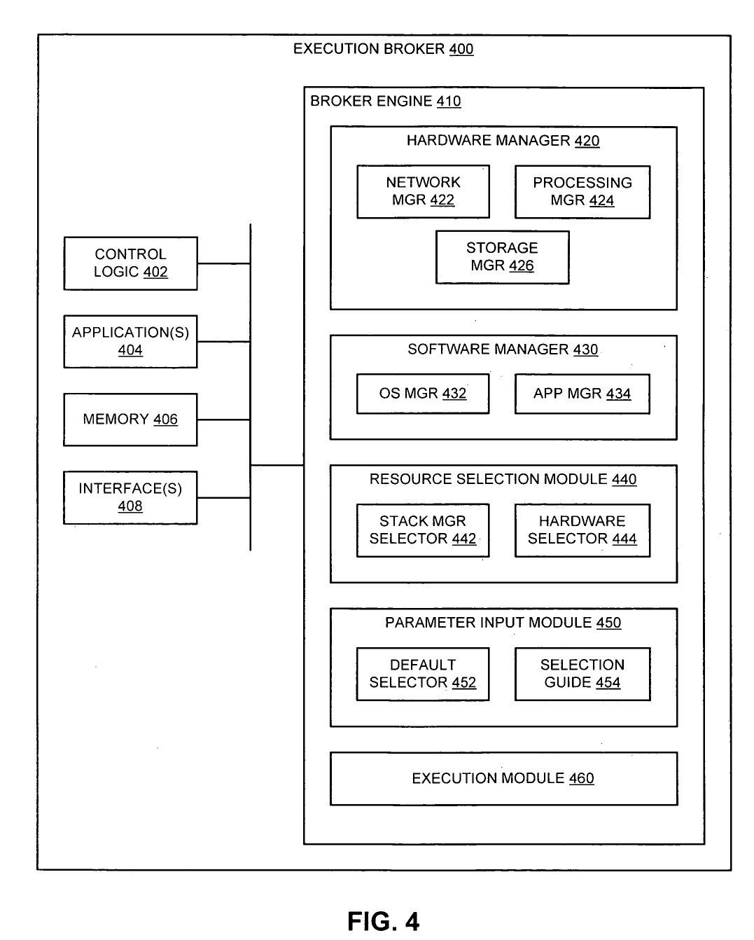

FIG. 4 is a block diagram of an embodiment of an execution broker. Execution broker 400 includes control logic 402, which implements logical functional control to direct operation of execution broker 400, and/or hardware associated with directing operation of execution broker 400. Logic may be hardware logic circuits and/or software routines. In one embodiment, execution broker 400 includes one or more applications 404, which represent code sequence and/or programs that provide instructions to control logic 402. Execution broker 400 includes memory 406 and/or access to memory resource 406 for storing data and/or instructions. Memory 406 may include memory local to execution broker 400, as well as, or alternatively, including memory of the host system (e.g., on a server) on which execution broker 400 resides. Execution broker 400 also includes one or more interfaces 408, which represent access interfaces to/from (an input/output interface) execution broker 400 with regard to entities (electronic or human) external to execution broker 400.

Execution broker 400 also includes broker engine 410, which represents one or more functions that enable execution broker 400 to provide dynamic provisioning and execution of applications. The functions or features include, or are provided by, one or more of hardware manager 420, software manager 430, resource selection module 440, parameter input module 450, and/or execution module 460. Each of these modules may further include other modules to provide other functions. As used herein, a module refers to routine, a subsystem, etc., whether implemented in hardware, software, or some combination.

Hardware manager 420 provisions hardware resources in response to receiving a request from a client. Hardware manager 420 may include additional modules, including network manager 422 to generate and manage network resources, processing manager 424 to generate and manage processing or computing resources, and storage manager to generate and manage storage resources. Hardware manager 420 may provision resources from stack managers local to execution broker 400, as well as, or alternatively, from stack managers external or remote to execution broker 400.

Software manager 430 provisions a software environment on which to execute an application, and provides and executes the application. Software manager 430 may include OS manager 432 to provision and manage operating systems, and application (app) manager 434 to provision and execute a requested software application, and/or provision other applications required to execute a requested application. Software manager 430 may provision resources from stack managers local to execution broker 400, as well as, or alternatively, from stack managers external or remote to execution broker 400.

Resource selection module 440 enables broker engine 410 to select from among multiple available resources and determine which resources to use. Resource selection module 440 may include stack manager selector 442 and hardware selector 444. Stack manager selector 442 provides control logic to determine which of multiple known stack managers (local and/or external) should be used to provision the necessary application execution environment. Additionally, hardware selector 444 enables resource selection module 440 to select from among many potential hardware resources, as discussed previously. Resource selection module 440 may provide a default configuration selection. If the default configuration is modified, the modified configuration will be provisioned. However, if the client does not object to the default configuration, the default configuration is provisioned. Resource selection module 440 provides an execution environment generated in response to a request, and consistent with or based upon a configuration associated with the request. The configuration can be associated with the request because it is received with the request, or because execution broker 400 identifies resources that satisfy the request. When backend systems that may have pre-configured resource combinations are used to fulfill the request, resource selection module 440 may include heuristics engines to determine a “closeness” of one configuration to another to suggest the configuration as a default, or to provision the configuration.

Parameter input module 450 provides interface mechanisms and logic to provide a mechanism for execution broker 400 to receive input requests from clients and solicit input to determine an execution environment. Parameter input module 450 may include default selector 452, which works in conjunction with, or in place of a similar mechanism that could be part of resource selection module 440. Default selector 452 additionally presents the default selection to the requesting client to solicit input, and potentially modify the suggested configuration. Parameter input module 450 may also include selection guide 454, which represents a guided procedure agent, a wizard, or other mechanism through which parameter input module 450 can obtain client input on the requested execution environment configuration. Selection guide 454 may further include access to, and/or may store, client preferences that may influence the selection of a default or other configuration.

Execution module 460 enables broker engine 410 to launch the application on the created system, and provide necessary information to the client to enable the client to access and use the application.

In one embodiment, execution broker 400 is a real broker. A real broker is aware of some or many stack managers (e.g., a manager of broker engine 410). Depending on certain policies and rules, execution broker 400 can choose an application stack manager most appropriate for a given request. The decisions can be influenced by a client (e.g., when a client selects high performance, or inexpensive virtualized resources). In an alternate embodiment, execution broker 400 is not a real broker. Execution broker 400 may simply be aware of its application stack managers and always use its managers. Thus, execution broker 400 may or may not access remote managers for access to resources.

In one embodiment, application stack managers (e.g., the managers of broker engine 410) do not always create required resources. For example, a manager may copy of clone a resource, obtain the resource from a cache, or provide an image with the corresponding resource. In one embodiment, application stack managers work synchronously, and await the occurrence of particular conditions prior to executing (e.g., a manager may work in conjunction with another manager). Application stack managers may also work asynchronously (i.e., in parallel with other application stack managers) and notify clients upon completion of work.

Execution broker 400 may include hardware, software, and/or a combination of these. In a case where execution broker 400 or its constituent components includes software, the software data, instructions, and/or configuration may be provided via an article of manufacture by a machine/electronic device/hardware. An article of manufacture may include a machine readable medium having content to provide instructions, data, etc. The content may result in an electronic device as described herein, performing various operations or executions described. A readable accessible medium includes any mechanism that provides (i.e., stores and/or transmits) information/content in a form accessible by a machine (e.g., computing device, electronic device, electronic system/subsystem, etc.). For example, a machine readable medium includes recordable/non-recordable media (e.g., read only memory (ROM), random access memory (RAM), magnetic disk storage media, optical storage media, flash memory devices, etc.). The machine readable medium may further include an electronic device having code loaded on a storage that may be executed when the electronic device is in operation. Thus, delivering an electronic device with such code may be understood as providing the article of manufacture with such content described herein. Furthermore, storing code on a database or other memory location and offering the code for download over a communication medium may be understood as providing the article of manufacture with such content described herein.

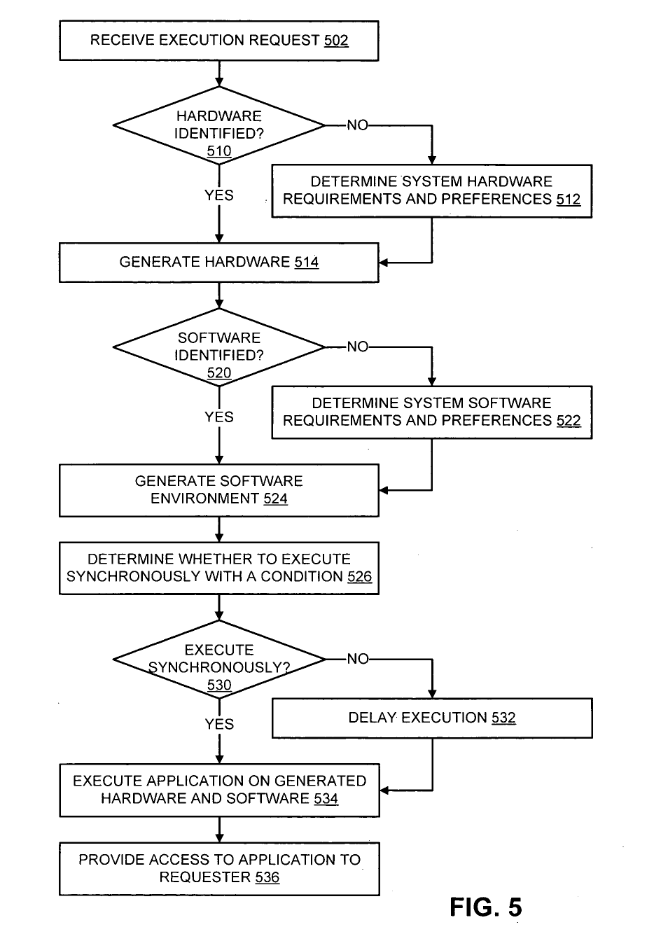

FIG. 5 is a flow diagram of an embodiment of brokering execution of an application. A brokering entity (i.e., an execution broker) receives a request to execute an application, 502. The execution broker determines whether or not the received request includes a description or an identification of the hardware, 510. If the hardware is not identified, the execution broker determines system hardware requirements, which may include accounting for client preferences, 512. The preferences can be received prior, with, or after the request, and can be used to indicate a required parameter in the configuration. Determining system requirements has been discussed previously, and is not repeated here. The execution broker then generates the hardware, 514, which may include virtualized and/or non-virtualized components.

The execution broker determines whether or not the received request includes a description or an identification of the software configuration, 520. If the software environment configuration is not identified, the execution broker determines system software requirements, which may include accounting for client preferences, 522. The preferences can be received prior, with, or after the request, and can be used to indicate a required parameter in the configuration. The execution broker then generates the software, 524, which may include virtualized and/or non-virtualized components.

The execution broker determines whether to execute synchronously with a condition, 526. The condition may relate to the occurrence of an event or be based upon the provisioning of other managers. Thus, execution may be asynchronous with respect to certain managers. In one embodiment, client preferences may indicate whether or not certain resources can be used synchronously or should be used asynchronously. If the application execution is to be performed synchronously, 530, execution of the application may be delayed, 532.

Whether delayed or not, the execution broker executes the application on the generated hardware and software, 534. The execution broker can then provide access to the resources to requester, 536.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method for providing an application execution environment, comprising:
receiving a request to execute an application, including a configuration description of a hardware platform and a software environment on which to execute the application;
generating a hardware platform based on the configuration description, in response to receiving the request;
generating a software environment based on the software environment of the configuration description, in response to receiving the request; and
executing the application on the hardware platform in the software environment.

2. The method of claim 1, wherein receiving the request including the configuration description further comprises:
receiving a request for a specified application;
determining a minimum hardware platform configuration required to execute the application; and
determining a minimum software environment configuration required to execute the application.

3. The method of claim 1, wherein generating the hardware platform based on the configuration description comprises:
suggesting a default hardware configuration;
determining whether to modify the default hardware configuration to a modified suggested hardware configuration; and
generating a hardware platform based on the modified suggested hardware configuration if it is determined to modify the default hardware platform configuration, otherwise,
generating a hardware platform based on the default hardware configuration.

4. The method of claim 3, wherein determining whether to modify the default hardware configuration further comprises:
comparing the default hardware configuration to known configuration preferences.

5. The method of claim 3, wherein determining whether to modify the default hardware configuration further comprises:
receiving configuration preferences; and
comparing the default hardware configuration to the received configuration preferences.

6. The method of claim 3, wherein determining whether to modify the default hardware configuration further comprises:
evaluating the default hardware configuration for one or more of a cost, a quality of service, a guaranteed service level, an availability of the hardware.

7. The method of claim 1, wherein generating the hardware platform based on the configuration description comprises:
identifying a known physical hardware system having at least a minimum of elements of the hardware platform configuration description; and
preferring the known physical hardware system over generating a virtualized hardware platform that matches the hardware platform configuration description.

8. The method of claim 1, wherein generating the hardware platform comprises:
virtualizing at least one component of the hardware platform.

9. The method of claim 1, wherein generating the software environment based on the configuration description comprises:
suggesting a default software configuration;
determining whether to modify the default software configuration to a modified suggested software configuration; and
generating a software environment based on the modified suggested software configuration if it is determined to modify the default software environment configuration, otherwise,
generating a software environment based on the default software configuration.

10. The method of claim 1, wherein generating the software environment comprises:
retrieving a software component from a node on a shared network.

11. The method of claim 1, wherein generating the software environment comprises:
virtualizing at least one component of the software platform.

12. The method of claim 1, further comprising:
delaying execution of the application on the hardware platform in the software environment.

13. The method of claim 12, wherein delaying execution of the application further comprises:
delaying the execution to synchronize the execution with the occurrence of a condition.

14. The method of claim 13, wherein the occurrence of the condition comprises one or more of achieving a target cost, obtaining availability of a hardware resource, or obtaining availability of a software resource.

15. An article of manufacture comprising a machine readable medium having content stored thereon to provide instructions to cause a machine to perform operations, including:
receiving from a client a request to execute an application;
determining a configuration description of a hardware platform and a software environment on which to execute the application;
virtualizing a hardware platform consistent with the configuration description, in response to receiving the request;
virtualizing a software environment consistent with the software environment of the configuration description, in response to receiving the request; and
executing the application on the virtualized hardware platform in the virtualized software environment.

16. The article of manufacture of claim 15, wherein the content for determining the configuration description comprises content for:
providing a suggested virtualized hardware platform configuration; and
generating a virtualized hardware platform configuration according to a modification of the suggested virtualized hardware platform configuration, if a modification of the suggested virtualized hardware platform configuration is received, otherwise,
generating a virtualized hardware platform configuration according to the suggested virtualized hardware platform configuration.

17. The article of manufacture of claim 15, wherein the content for determining the configuration description comprises content for:
providing a suggested virtualized hardware platform configuration; and
generating a virtualized software environment configuration according to a modification of the suggested virtualized software environment configuration, if a modification of the suggested virtualized software environment configuration is received, otherwise,
generating a virtualized software environment configuration according to the suggested virtualized software environment configuration.

18. An execution broker comprising:
a hardware manager to generate one or more hardware resources;
a software manager to generate one or more software resources;
a resource selector coupled to the hardware manager and the software manager, the resource selector to receive a request to execute an application, select a hardware resource configuration on which to execute the application in response to receiving the request, and select a software resource configuration on which to execute the application in response to receiving the request; and
an execution module coupled to the resource selector to execute the application on the selected hardware and the selected software, and provide access to the application to a requester.

19. The execution broker of claim 18, wherein the software manager further comprises:
an operating system manager coupled to an operating system repository to retrieve an operating system from the repository.

20. The execution broker of claim 18, wherein the software manager further comprises:
an application manager coupled to an application repository to retrieve an application from the repository.

21. A system comprising:
a long-running backend system having allocatable hardware and software resources;
a hardware manager coupled to the backend system to allocate one or more of the allocatable hardware resources;
a software manager coupled to the backend system to allocate one or more of the allocatable software resources;
an execution broker coupled to the hardware manager and to the software manager, the execution broker including a resource selector to receive a request from a requester to execute an application, select a hardware resource configuration on which to execute the application in response to receiving the request, and select a software resource configuration on which to execute the application in response to receiving the request, and further including an execution module to broker the allocatable hardware and software resources to the requester via the hardware and software managers, and to execute the application on the brokered hardware and software.

22. The system of claim 21, wherein the hardware manager is included with the execution broker.

23. The system of claim 21, wherein the software manager is included with the execution broker.

24. The system of claim 21, further comprising:
a requester access module to couple the requester to the execution broker and the brokered hardware and software resources.

25. The system of claim 24, wherein the requester access module comprises a remote access portal.
